(19) United States
(12) Patent Application Publication
(10) Pub. No.: US 2013/0080010 A1
(43) Pub. Date: Mar. 28, 2013

(54) Clutch Protection System

(71) Applicants: Joseph A. Cullen, Waterloo, IA (US); Tara A. Sundt, Cedar Falls, IA (US)

(72) Inventors: Joseph A. Cullen, Waterloo, IA (US); Tara A. Sundt, Cedar Falls, IA (US)

(21) Appl. No.: 13/242,198

(22) Filed: Sep. 23, 2011

(51) Int. Cl. G06F 7/00

(52) U.S. Cl. 701/67

(57) ABSTRACT

A vehicle having a chassis, an engine supported by the chassis, a clutch assembly and a controller. The clutch assembly contains a clutch that is coupled to the engine. The controller executes a method to protect the clutch, the method including the steps of calculating, comparing and derating. The calculating step includes calculating the amount of energy being absorbed by the clutch. The comparing step compares the amount of energy to a predetermined limit. The derating step derates the engine dependent upon whether the amount of energy exceeded the predetermined limit in the comparing step.

### FIELD OF THE INVENTION

The present invention relates to an engine with a clutch attached thereto, and, more particularly, to an engine/clutch combination with a clutch protection method and apparatus.

### BACKGROUND OF THE INVENTION

A power source, such as an engine is often connected to a clutch assembly, which allows for the selective engagement and disengagement of rotating power from the power source to a load. Often the engine is connected by way of the clutch to a transmission, for example in a vehicle. Clutches typically are employed in devices which have two rotating shafts. One shaft is typically connected to the power unit and the other shaft provides the output power to the transmission or load. The clutch connects the two shafts so that they may be locked together and spin at the same speed when they are in an engaged position and the shafts may spin at different speeds when the clutch is disengaged. Clutches typically depend upon a frictional interface between a plate connected to one shaft and a plate connected to another shaft with the clutch often having a surface with a known frictional coefficient that is durable enough to withstand the demands of the power transfer through the clutch assembly. Organic and ceramic frictional materials are typically used.

There are dry clutches and wet clutches with the dry clutch being, as the name implies, literally dry. A wet clutch is immersed in a fluid that functions as a cooling and lubricating fluid and it keeps the surfaces clean giving smooth performance and longer life of the clutch assembly. Wet clutches lose some energy to the liquid, which then allows for cooling of the clutch. Since the surfaces of a wet clutch can he somewhat slippery the stacking of multiple clutch discs are often used to compensate for the lower coefficient of friction to help eliminate any slippage under power when the clutch disks are engaged.

There is a safety clutch also known as a slip clutch that allows a rotating shaft to slip when a higher than normal resistance is encountered in the machine application. For example, a safety clutch may be employed in a grass mower so that the safety clutch will yield in the event that a blade hits an immovable object to thereby prevent damage to the mower.

What is needed in the art is a clutch system that detects potential degraded performance in the clutch and takes steps to protect the clutch in an effective manner.

### SUMMARY

The present invention provides a method of protecting a clutch assembly in a vehicle including the steps of calculating an amount of energy absorbed by a clutch, comparing the energy to a predetermined limit, and derating an engine coupled to the clutch. The engine being derated dependent upon whether the amount of energy exceeds a predetermined limit in the comparing step.

The invention in another form is directed to a vehicle having a chassis, an engine supported by the chassis, a clutch assembly and a controller. The clutch assembly contains a clutch that is coupled to the engine. The controller executes a method to protect the clutch, the method including the steps of calculating, comparing and derating. The calculating step includes calculating the amount of energy being absorbed by the clutch. The comparing step compares the amount of energy to a predetermined limit. The derating step derates the engine dependent upon whether the amount of energy exceeded the predetermined limit in the comparing step.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical top view of an embodiment of the clutch system of the present invention utilized by a power transfer apparatus as part of a vehicle; and

FIG. 2 is a schematical view of an embodiment of the method employed by the clutch protection system of FIG. 1.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION

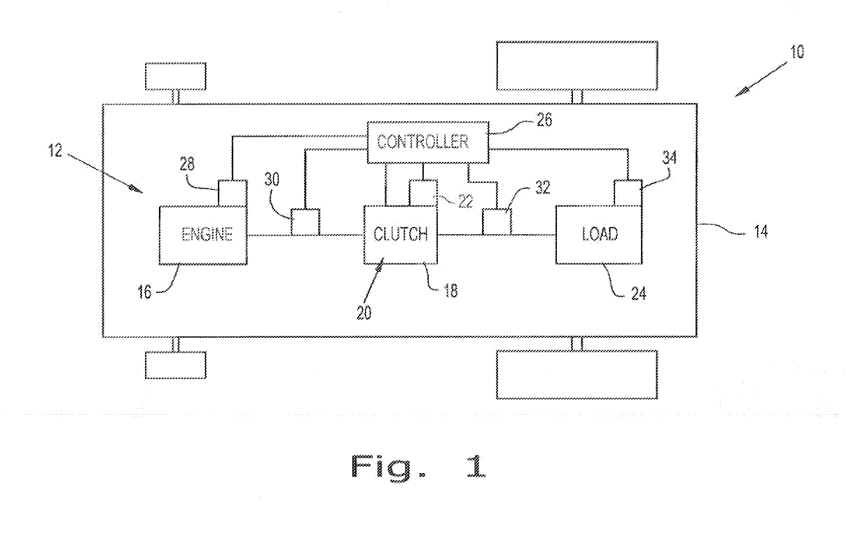

Referring now to the drawings, and more particularly to FIG. 1, there is illustrated a vehicle 10 having a power system 12 that is connected to various parts of vehicle 10. Power system 12 is situated on a chassis 14 of vehicle 10. Power system 12 includes an engine 16, a clutch assembly 18 having a clutch 20 and a clutch cooling system 22. Connected to clutch assembly 18 is a load 24. Load 24 represents any load that is being driven by engine 16 by way of clutch assembly 18, including a transmission that may immediately follow and be connected to clutch assembly 18. Engine 16 may be an internal combustion engine such as a diesel engine and with the use of the present invention, engine 16 may be a high power engine while clutch assembly 18 may be a clutch assembly 18 that would normally not be associated with engine 16 except for the ability of the present invention to protect clutch assembly 18 and thereby power system 12.

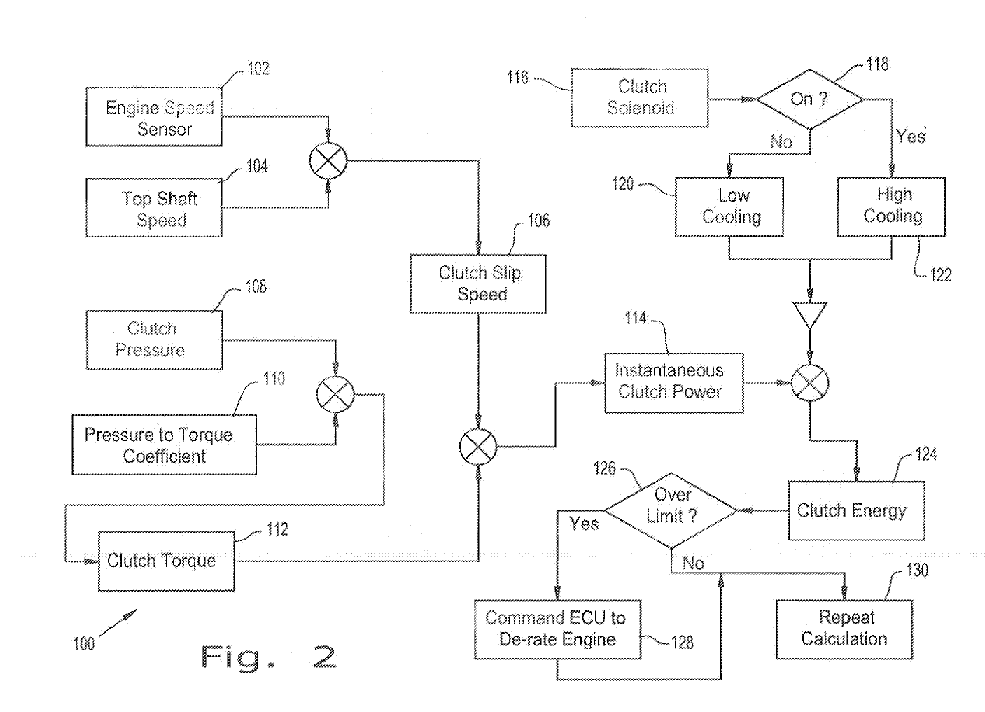

Additionally associated with power system 12 is a controller 26 that interacts with engine control unit 28, shaft speed sensor 30, shaft speed sensor 32 and a load sensor 34. Additionally controller 36 interfaces with clutch cooling system 22. The term interface is broadly applied and includes providing information to and receiving information from various interconnections. Controller 26 is illustrated as a separate device but it may be incorporated into engine control unit 28 or be separately positioned on chassis 14 or be associated directly with clutch assembly 18. Controller 26 and the methods carried out therein may be carried out in a digital, analog or a combination of digital and analog electrical embodiments. Further, it is also anticipated that the present method may be carried out with fluidic logic or other fluidic control systems. For the sake of clarity it will be assumed that controller 26 is an electrical digital controller. Controller 26 has a processing system as well as memory for the storage of data and programming steps including the steps of method 100 illustrated in FIG. 2.

Now, additionally referring to FIG. 2 there is illustrated a method 100 for explanation of an embodiment of the present invention. Method 100 includes using information coming from an engine speed sensor at step 102 and more specifically the speed of the shaft coming from engine 16 which is sensed by shaft speed sensor 30. The output speed of the top shaft transferring power from clutch assembly 18 is measured by shaft speed sensor 32, which takes place at step 104. The input speed measured at step 102 and the output speed measured at step 104 are compared to result in a clutch slip speed at step 106. The clutch slip speed is a calculated value and may be the difference between the input speed at step 102 and the output speed at step 104 to thereby compute the clutch slip speed of step 106. Controller 26 receives the clutch pressure at step 108 which is measured by a sensor in clutch assembly 18. The clutch pressure is combined with the pressure to torque coefficient, illustrated at step 110, the combination of the clutch pressure From step 108 having the pressure to torque coefficient from step 110 applied thereto results in the clutch torque at step 112. Mathematical elements associated therewith may be a multiplication between the clutch pressure obtained at step 108 and the use of the coefficient from step 110. The pressure to torque coefficient is a constant that is determined by the geometry or the clutch such as the size of the plates and the number of plates in the clutch assembly 18.

The clutch slip speed from step 106 and the clutch torque from step 112 are combined mathematically, for example by way of multiplication; the result is the instantaneous clutch power at step 114. This is a calculation of the power absorbed by clutch assembly 18 and is not being transmitted by way of the output shaft. Instantaneous clutch power is a measure of power being absorbed potentially by the fluid of a wet clutch assembly.

The clutch solenoid in clutch assembly 18 is either activated or not activated, either under the control of controller 26 or as detected by a sensor detecting the activation of the clutch solenoid at step 116. If the clutch solenoid is on, as detected in step 118, then method 100 proceeds to step 122 where a high cooling condition of clutch assembly 18 is being undertaken. If the clutch solenoid is detected as not being on, at step 118, then low cooling is the mode of operation as illustrated by step 120. Information as to whether clutch cooling system 22 is active at a low or high level is combined with the instantaneous clutch power from step 114 to result in the overall calculation of the clutch energy being absorbed by clutch assembly 18 at step 124. The instantaneous clutch power and the effect of cooling system 22 is integrated over time to calculate the absorbed clutch energy at step 124. This calculation is a cumulative calculation such as integration or as digital numeric integration of data values arrived at over short time intervals, such as 100 msec time intervals. This calculated absorbed energy of clutch assembly 18 is then compared to a predetermined value at step 126 to determine if the absorbed clutch energy is over the predetermined limit. If the clutch energy is over the predetermined limit then method 100 proceeds to step 128 in which engine control unit 28 is either requested or commanded to derate the power output of engine 16 by a predetermined value, such as 15%. This is carried out by controller 26 sending information to engine control unit 28 to derate engine 16. Method 100 then proceeds to step 130 where method 100 is repeated, perhaps, for example, every 100 milliseconds. If at step 126 it is determined that the clutch energy is not over the predetermined limit then method 100 proceeds to step 130 in which method 100 is repeated.

The present invention protects not only the clutch assembly 18 but may additionally protect elements of load 24 such as a transmission. If the clutch energy calculated at step 124 exceeds a specified threshold at step 126, controller 26 requests that engine 16 be derated by the predetermined amount of 15%, although other values are also contemplated. When the cumulative clutch energy is measured at step 124 and it is less than a second predetermined limit, which is less than the limit used at step 126 to determine that engine 16 should be derated at step 128, then the request for the engine to be derated is removed and the power potentially available from engine 16 is subsequently increased. The second predetermined limit may be 80% (although other values are also contemplated) of the limit used in step 126 to determine that engine 16 should be derated, thus providing for a hysteresis in the system to prevent the engine power from changing excessively when the absorbed energy lingers around the predetermined limit used to derate engine 16.

The clutch slip speed at step 106 can also be thought of as a clutch slip percentage if a ratio is computed from the input shaft speed at step 102 and the output shaft speed at step 104. These are calculated if engine 16 is running and clutch 20 is partially or fully engaged. The clutch slip speed in RPMs can he calculated as the absolute value of:

((Engine Speed×Current Gear Ratio)−Top Shaft Speed)
with the Current Gear Ratio referring to any gearing that is present between engine 16 and clutch assembly 18, which once applied to the Engine Speed yields the speed of the input shaft of clutch assembly 18.

The Clutch slip percentage can be calculated as:

Ratio=Top Shaft Speed/(Engine Speed×Current Gear Ratio)

% Slip=(1−Ratio)×100%

Slip=(100−[(Top Shaft Speed×100)/(Engine Speed×Current Gear Ratio)])

Cumulative clutch enemy can be expressed in decajoules. Cumulative clutch energy that is calculated at step 124 can he initialized to zero at the power-up of power system 12. The cumulative clutch energy can he a positive value for example in the range of 0-64,000. If engine 16 is running and clutch 20 is engaged, either partially or fully, the following actions are taken as a calculation of the instantaneous clutch energy; the instantaneous clutch energy is added to the cumulative clutch energy at step 124; a calculation is carried out to compute the cooling clutch energy which is then subtracted from the cumulative clutch energy. There is also a relationship between the clutch input torque and the measured pressure of the traction clutches. The clutch input torque is mapped to measured enable pressure using the following relationship:

Input_Torque [Nm]=Measured_Enabled_Pressure [kPa]×0.6−140

There can be table data populated with the clutch cooling rate versus the measured enabled pressure for the forward traction clutch. Clutch 20 cooling rates retrieved from this table can be interpolated with respect to the pressure. This table can be thought of as the clutch cooling rate versus enabled pressure and is provided as an example:

| Enable | Heat Removed [kJ/sec] |
|---|---|
| Pressure | [kJ/sec] −> [decajoules for each |
| [kPa] | 100 msec] |
| 1500 | 42.0 −> 420 |
| 1425 | 42.0 −> 420 |
| 1350 | 42.0 −> 420 |
| 1275 | 42.0 −> 420 |
| 1200 | 42.0 −> 420 |
| 1125 | 42.0 −> 420 |
| 1050 | 42.0 −> 420 |
| 975 | 42.0 −> 420 |
| 900 | 42.0 −> 420 |
| 825 | 42.0 −> 420 |
| 750 | 42.0 −> 420 |
| 675 | 42.0 −> 420 |
| 600 | 42.0 −> 420 |
| 525 | 42.0 −> 420 |
| 450 | 42.0 −> 420 |
| 375 | 42.0 −> 420 |
| 300 | 42.0 −> 420 |
| 225 | 31.5 −> 315 |
| 150 | 15.8 −> 158 |
| 75 | 6.6 −> 66 |
| 0 | 6.6 −> 66 |

Once the clutch input torque is known at step 112 power going into clutch 20 can be calculated by multiplying the clutch input torque by the clutch slip speed and dividing by a constant. Factoring in time then converts the clutch power to clutch energy, which is undertaken in step 124. Controller 26 carries out the calculation in units of decajoules. A software implementation is illustrated in the following calculations and rules:

Clutch Power=(input_Torque(Nm)*clutch_slip_speed(RPM))/9550 [kW]

Clutch Energy every 100 msec=Clutch Power*Time=Clutch Power*100 ms=Clutch Power/10,

Clutch Energy every 100 msec=[input_Torque*clutch_slip_speed]/95500 [kJ]

Clutch Energy every 100 msec=[input_Torque*clutch_slip_speed]/9550 [0.1 kJ]

Clutch Energy every 100 msec=[input_Torque*clutch_slip_speed]/955 [0.01 kJ]

converting to units of decajoules

As another way of understanding the present invention, it can be thought of as a set of rules that can be executed by a rule driven processing system, those rules being:
Rule 1—If cumulative clutch energy’ exceeds a first threshold value, then controller 26 shall request a 15% engine power derate.
Rule 2—If engine power is being derated AND cumulative clutch energy is less than a second (lower) threshold, then controller 26 shall stop requesting the engine power derate.

Additional Alternative Rules:
Rule 3—If cumulative clutch energy exceeds the first threshold, then controller 26 shall report a fault code that indicates that the clutch has been slipping for too long.
Rule 4—If the fault code indicating that the clutch has been slipping for too long is active AND the cumulative clutch energy is less than the second threshold, then controller 26 shall slop reporting the fault code.

The present invention advantageously protects the clutch assembly from being overdriven when it is detected that clutch 20 is slipping along with the detection of clutch energy being increasingly absorbed in clutch assembly 18. This advantageously allows for coupling of a higher power engine 16 to clutch assembly 18 as well as reducing the amount of needed maintenance, since clutch assembly 18 is protected by the present invention. Although not illustrated it is understood that information about the function of method 100 can he presented to an operator by way of an operator interface and data obtained can also be stored in memory for later retrieval by maintenance personnel.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of protecting a clutch assembly in a vehicle, comprising the steps of:
calculating an amount of energy being absorbed by a clutch;
comparing said amount of energy to a predetermined limit; and
derating an engine coupled to said clutch dependent upon whether said amount of energy exceeds said predetermined limit in said comparing step.

2. The method of claim 1, wherein said calculating step includes determining an instantaneous amount of power being absorbed by said clutch.

3. The method of claim 2, wherein said instantaneous amount of power is calculated from a slip speed of said clutch and a torque being transferred by said clutch.

4. The method of claim 3, wherein said slip speed is determined by:
measuring an input speed of a shaft entering said clutch;
measuring an output speed of a shaft of said clutch; and
taking a difference between said input speed and said output speed to thereby determine said slip speed.

5. The method of claim 4, wherein said torque is determined by:
measuring a pressure applied to said clutch; and
mathematically applying a pressure-to-torque coefficient to said pressure to arrive at said torque.

6. The method of claim 2, wherein said calculating step additionally includes factoring in an amount of cooling of said clutch that is taking place by a clutch cooling system.

7. The method of claim 6, wherein said amount of cooling is dependent upon a cooling mode selection of said clutch cooling system.

8. A vehicle, comprising:
a chassis;
an engine supported by said chassis;
a clutch assembly containing a clutch, said clutch assembly coupled to said engine; and
a controller executing a method to protect said clutch, the method including the steps of:
calculating an amount of energy being absorbed by said clutch;
comparing said amount of energy to a predetermined limit; and
derating said engine dependent upon whether said amount of energy exceeds said predetermined limit in said comparing step.

9. The vehicle of claim 8, wherein said calculating step includes determining an instantaneous amount of power being absorbed by said clutch.

10. The vehicle of claim 9, wherein said instantaneous amount of power is calculated from a slip speed of said clutch and a torque being transferred by said clutch.

11. The vehicle of claim 10, wherein said slip speed is determined by:
measuring an input speed of an input shaft entering said clutch;
measuring an output speed of an output shaft of said clutch; and
taking a difference between said input speed and said output speed to thereby determine said slip speed.

12. The vehicle of claim 11, wherein said torque is determined by:
measuring a pressure applied to said clutch; and
mathematically applying a pressure-to-torque coefficient to said pressure to arrive at said torque.

13. The vehicle of claim 9, wherein said calculating step additionally includes factoring in an amount of cooling of said clutch that is taking place by a clutch cooling system.

14. The vehicle of claim 13, wherein said amount of cooling is dependent upon a cooling mode selection of said clutch cooling system.

15. A power system having a clutch assembly connected to an engine, comprising a controller coupled to the engine and to the clutch assembly, the controller executing a method to protect a clutch in said clutch assembly, the method including the steps of:
calculating an amount of energy being absorbed by said clutch;
comparing said amount of energy to a predetermined limit; and
derating the engine dependent upon whether said amount of energy exceeds said predetermined limit in said comparing step.

16. The power system of claim 15, wherein said calculating step includes determining an instantaneous amount of power being absorbed by said clutch.

17. The power system of claim 16, wherein said instantaneous amount of power is calculated from a slip speed of said clutch and a torque being transferred by said clutch.

18. The power system of claim 17, wherein said slip speed is determined by:
measuring an input speed of an input shaft entering said clutch;
measuring an output speed of an output shaft of said clutch; and
taking a difference between said input speed and said output speed to thereby determine said slip speed.

19. The power system of claim 18, wherein said torque is determined by:
measuring a pressure applied to said clutch; and
mathematically applying a pressure-to-torque coefficient to said pressure to arrive at said torque.

20. The power system of claim 16, wherein said calculating step additionally includes factoring in an amount of cooling of said clutch that is taking place by a clutch cooling system.
